(19) United States
(12) Patent Application Publication
(10) Pub. No.: US 2007/0074755 A1
(43) Pub. Date: Apr. 5, 2007

(54) Photovoltaic module with rigidizing backplane

(75) Inventors: Chris Eberspacher, Palo Alto, CA (US); Phillip Capps, Mountain View, CA (US); John Holager, Oslo (NO)

Correspondence Address: JOSHUA D. ISENBERG;JDI PATENT, 809 CORPORATE WAY, FREMONT, CA, 94539, US

(73) Assignee: Nanosolar, Inc., Palo Alto, CA (US)

(21) Appl. No.: 11/243,522

(22) Filed: Oct. 3, 2005

(51) Int. Cl. H02N 6/00

(52) U.S. Cl. 136/244

(57) ABSTRACT

Solar cell modules and mounting methods are disclosed. A solar cell module includes one or more photovoltaic (PV) cells arranged in a substantially planar fashion. Each PV cell has a front side and a back side. The PV cells are adapted to produce an electric voltage when light is incident upon the front side. A rigid back plane is attached to the PV cells such that the back plane provides structural support from the back side. The rigid back plane includes a structural component having a plurality of voids.

### FIELD OF THE INVENTION

This invention is related to photovoltaic device modules and more particularly to mounting of photovoltaic device modules.

### BACKGROUND OF THE INVENTION

Solar power systems utilize large arrays of photovoltaic (PV) cells to convert the power of sunlight into useful electrical power. Arrays of PV cells are typically assembled into multi-cell modules that can be assembled and installed on site. As the efficiency of PV cells increases and the unit costs of solar cells arrays decline solar power systems could be economically attractive alternatives to conventional electric grid power. Even with improved efficiency, however, there are a number of practical challenges associated with installation and mounting of PV modules.

In particular, in the prior art most PV modules were of a rigid design, e.g., as illustrated in FIG. 1. A rigid PV module 100 includes a rigid transparent front cover 102 (e.g., glass), a plurality of solar cells 104 embedded in a pottant 106 (e.g., ethyl vinyl acetate (EVA)) and an encapsulant backsheet 108 (e.g., glass or a laminate of polyester between layers of polyvinyl fluoride). The laminated material of the backsheet 108 is often expensive.

The rigidity of the rigid PV module 100 typically accrues from a combination of the rigid front cover 102 and a rigid perimeter frame 110 (e.g. extruded aluminum). These typical rigidizing elements add considerable weight to the module 100 and restrict heat dissipation so that the temperature of typical modules is higher than would be case for a bare cell alone. These weight and temperature limitations are particularly evident in glass/glass modules that incorporate both a glass cover and a glass back sheet. Rigid modules dominate the present PV market in large part because fragile crystalline silicon cells generally require the mechanical protection (e.g. minimal bending, torsion, etc.) that rigid packaging can provide. In addition, the use of glass as the front cover 102 limits versatility in mounting the module 100. Since glass is generally difficult to machine, holes for mounting brackets and the like are typically formed in the frame 110. The overlap of the frame 110 with the front cover represents space that is unavailable for placement of the PV cells 104.

Some prior art commercial modules are flexible. FIG. 2 depicts an example of a prior art flexible PV module 200, which substitutes a flexible top sheet 202 (e.g., pliable plastic such as ethyl tetra fluorethylene (ETFE)) for rigid glass of the rigid module 100. The flexible module 200 can use bendable edge bumpers 210 in lieu of the rigid metal frame. Often, such flexible PV modules utilize the same type of laminated backsheet 108 as in the rigid module 100. While the flexible module 200 may be convenient for mobile applications (e.g. hiking, beach trips, etc.) where flexibility aids in dense packing and/or provides high power per weight ratio, flexible modules are not readily mounted on conventional mounting racks. Consequently, the market prospects for flexible modules are somewhat limited. Flexible packaging is generally used only with flexible solar cells, i.e. cells that do not to first order require the mechanical protection of rigid packaging.

A few commercial modules are semi-rigid; these modules generally incorporate some elements of flexible modules (e.g. flexible plastic cover sheets) but also incorporate some rigidizing elements (e.g. sheet metal backing). These modules provide some market sector cross-over potential (e.g. rigid enough for silicon-based PV cells but lighter than glass/metal packaging, lighter than traditional packaging but rigid enough to mount on standard mounting racks, etc.), but semi-rigid modules don't command a large share of the overall PV market. One of the key limitations of typical semi-rigid modules is that solid rigidizing elements (e.g. back sheets comprising sheet metal, fiberglass, stiff plastic sheet, etc.) add weight and limit heat flow, so that modules run hotter and weigh considerable more than flexible modules.

Thus, there is a need in the art, for a solar cell module that overcomes the above disadvantages.

### BRIEF DESCRIPTION OF THE DRAWINGS

The teachings of the present invention can be readily understood by considering the following detailed description in conjunction with the accompanying drawings, in which:

FIG. 1 is a cross-sectional schematic diagram of a rigid solar cell module according to the prior art.

FIG. 2 is a cross-sectional schematic diagram of a flexible solar cell module according to the prior art.

FIG. 3 is a cross-sectional schematic diagram of a solar cell module according to an embodiment of the present invention.

FIG. 4A is an exploded three-dimensional diagram of a solar cell module having a rigid back plane made with a honeycomb-type structural component according to an embodiment of the present invention.

FIG. 4B is an exploded three-dimensional diagram of a solar cell module having a rigid back plane made with a grate-type structural component according to an embodiment of the present invention.

FIG. 5 is a cross-sectional schematic diagram of a solar cell module according to an alternative embodiment of the present invention.

FIG. 6 is a cross-sectional schematic diagram of a solar cell module according to another alternative embodiment of the present invention.

FIG. 7 is a cross-sectional schematic diagram of a solar cell module according to yet another alternative embodiment of the present invention.

FIG. 8 is a cross-sectional schematic diagram of a solar cell module according to another alternative embodiment of the present invention.

FIG. 9 is a cross-sectional schematic diagram illustrating interlocking solar cell modules according to an embodiment of the present invention.

FIG. 10 is a plan view cross-sectional schematic diagram illustrating interlocking solar cell modules according to another embodiment of the present invention.

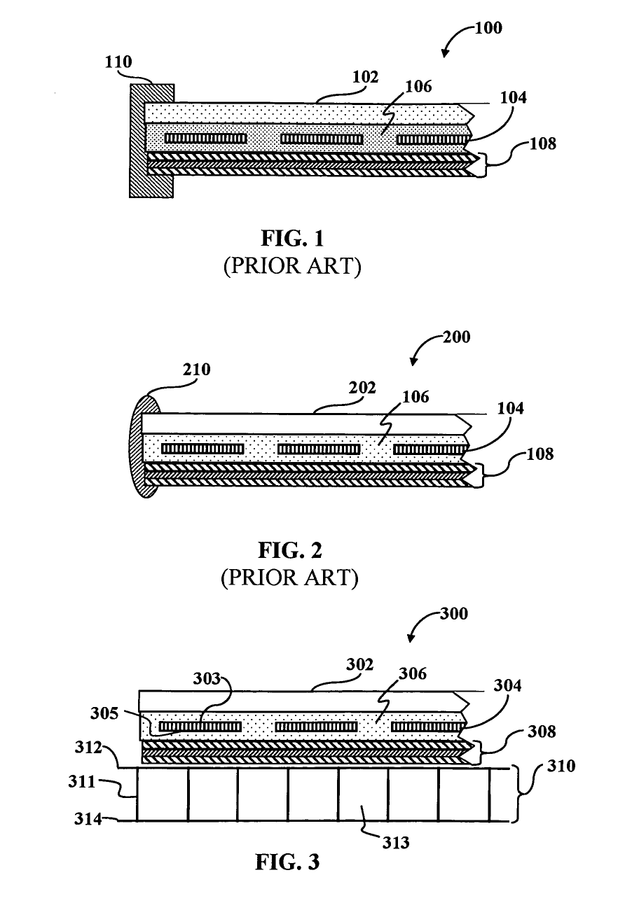

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the embodiments of the invention described below are set forth without any loss of generality to, and without imposing limitations upon, the claimed invention.

Embodiments of the present invention relate to a PV module having light-weight, temperature-moderating rigidizing elements. These rigidizing elements can be mated with an otherwise flexible module design so as to provide the market appeal of readily installed rigid modules with packaging know-how developed to serve flexible module markets.

FIG. 3 depicts a solar cell module 300 according to an embodiment of the invention. The module 300 has a flexible top sheet 302 (e.g., ETFE, which is sold by DuPont under the name Tefzel), a plurality of solar cells 304 embedded in a pottant 306 such as EVA, and a flexible back sheet 308 (e.g., a PVF-polyester-PVF laminate). Tefzel is a trademark of E. I. DuPont De Nemours and Company Corporation of Wilmington, Del. The PV cells 304 are arranged in a substantially planar fashion. Each solar cell has a front side 303 and a back side 305. One or more photovoltaic cells are adapted to produce an electric voltage when light is incident upon the front side 303. A rigid back plane 310 is attached to the one or more of the solar cells 304 such that the back plane provides structural support from the back side 305. In certain embodiments of the present invention, it is desirable for the back plane 310 the back plane to be made of a machinable material, e.g., a metal or plastic. This avoids the use of a frame that would otherwise cover space for the PV cells 304.

The rigid back plane 310 includes a structural component 311 having a plurality of voids 313. By way of example, the structural component 311 may structural component may be made any suitable material, e.g., plastics, polypropylene, polycarbonate, Styrofoam, concrete, metal, steel, copper, aluminum, carbon fibers, Kevlar, wood, plywood, fiberboard and other materials with similar elasticity or compressibility properties in the range of the foregoing materials. The voids 313 allow the back plane 310 to be relatively light in weight while maintaining strength. The voids 313 can also provide pathways for thermal conduction and/or convention. By way of example, and without limitation, the structural component may be in the form of a wire cloth, perforated material, molded material, fiberglass reinforced plastic grate, or expanded materials such as steel sheet expanded, GP unpolished low carbon steel, and similar expanded materials including those available through MarCo Specialty Steel (Houston, Tex.). Examples of suitable rigidizing elements include lattice-like material such as fiber-reinforced polymeric mesh, expanded metal, punched metal, etc. Lattice materials are available in sheet form and in a wide range of stiffnesses and weights. Lattice materials are used in easy-draining stairway treads, in warehouse mezzanines, and in outdoor platforms where strength, light-weight and good drainage are needed. Applying a lattice-like material as a rigidizing back plane to an otherwise flexible module can provide sufficient rigidity for easy mounting on traditional mounting racks and heat-dissipating ventilation on the back surface. The back plane 310 may further include front and back planar elements 312, 314 on either side of the structural component 311. The planar elements 312, 314 may provide thermal contact, electrical insulation, thermal insulation or structural rigidity to the structural component. The planar elements 312, 314 may include an additional fire-retarding backsheet that can be added on the lattice-like material in order to provide a favorable fire rating to an otherwise poorly-rated PV module. Lateral air flow passages in the lattice-like material can aid in air cooling, mitigating module heating.

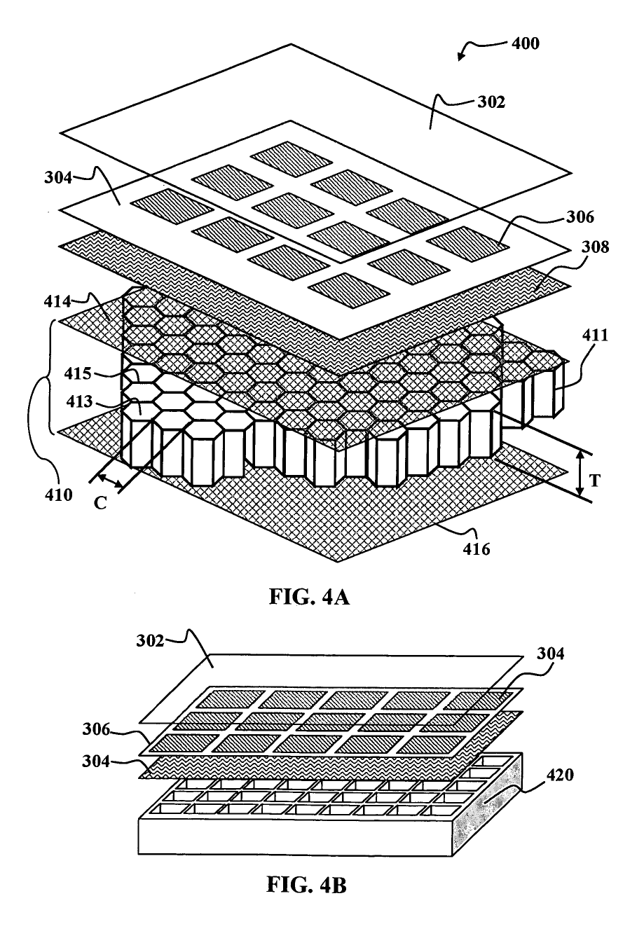

In a preferred embodiment, solar cell module 400 includes a rigid back plane 410 having a structural component in the form of a honeycomb material 411 as depicted in FIG. 4A. Voids in the form of hexagonal honeycomb channels 413 communicate across the thickness of the honeycomb material 411. By way of example, and without limitation, the honeycomb channels 413 may be characterized by a substantially uniform cell size c (measured e.g., between parallel faces of a channel) ranging from about 1/32″ to about 12″. The cell size is normally defined flat to flat. The honeycomb material may be characterized by a thickness T, which may range, e.g., from about 1/32″ to about 12″ or from about ¼″ to about ⅓″ or from about ⅛″ to about ½″. Suitable honeycomb materials are commercially available, e.g., under the name NidaCore from NidaCore Structural Honeycomb Materials of Port St. Lucie, Fla. Such honeycomb materials may be made of any suitable material, e.g., plastic such as polyethylene, polypropylene or polycarbonate or a metal, such as aluminum, copper or stainless steel.

Honeycomb materials may be flexible and easily bent out of a substantially planar shape. To provide rigidity to the back plane 410, the honeycomb material 411 may be rigidized with a planar element in the form of a skin 414 attached to a support surface 415 of the honeycomb material such that the skin 414 rigidizes the honeycomb material 411. As used herein, the term “support surface” refers to a surface of the honeycomb material that is used to support the array of solar cells 304. The support surface 415 may be either a front or a back surface. In some embodiments the honeycomb material 411 may be sandwiched between two sheets of skin material 414, 416. Material with a honeycomb core sandwiched between two layers of skin is commercially available from NidaCore.

The skin 414, 416 may be made of any suitable lightweight material, e.g., a woven scrim, a textile, plastic sheet or sheet metal, or combinations of these materials. The skin 414 may be attached to the honeycomb material 411 in any conventional fashion suitable for the materials involved, e.g., with appropriate adhesives, or with welding or solder in the case of metal skin and metal honeycomb. In some embodiments, a fiberglass cloth material may be used as the skin 414 and may be attached to plastic honeycomb material with an adhesive. Remarkably, even though both the skin and honeycomb materials are quite flexible, the resulting composite material can be quite rigid, even if skin is attached to only one side of the honeycomb material.

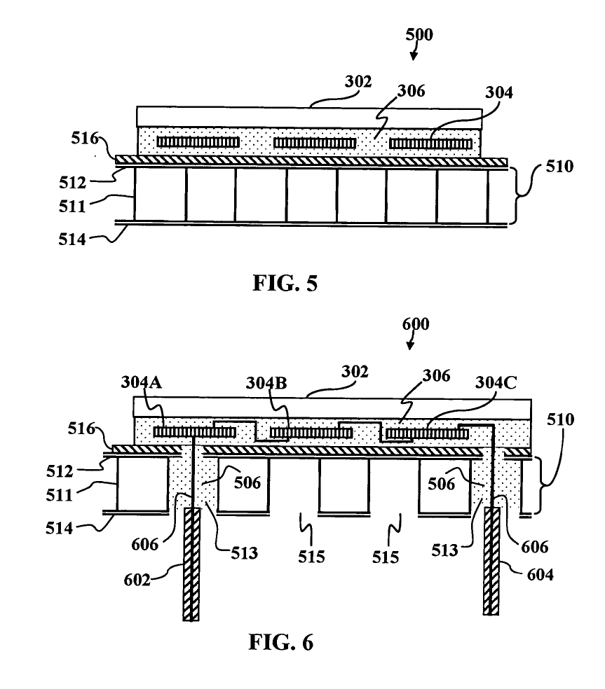

In some embodiments, the honeycomb material 411 and skin 414, 416 may be made of thermally conductive or electrically conductive materials, e.g., metals such as aluminum or copper. The use of such thermally conductive materials allows for efficient transfer of heat from the solar cells 304. Alternatively, the honeycomb and skin materials may be non-thermally conductive and/or electrically insulating materials such as plastic or fiberglass to provide electrical insulation between the back plane 410 and the solar cells 304. In some embodiments, the skin 416, 418 may be an electrically conductive material having an insulating coating between the electrically conductive material and the solar cells 304. For example, as depicted in FIG. 5, a solar cell module 500 has a back plane 510 made of a structural material, e.g., honeycomb disposed between an upper skin sheet 512 and a lower skin sheet 514. An insulating material 516 is disposed between the upper skin sheet 512 and one or more PV cells 304 embedded in a pottant 306. By way of example, and without loss of generality, the electrically insulating material may be a sheet of polyester. Alternatively, the upper skin sheet 512 may be made of aluminum with an oxidized surface providing an aluminum oxide coating that serves as the insulating material 516.

In an alternative embodiment of the present invention, the structural material 310 may be a rectangular grate 420 as depicted in FIG. 4B. The grate 420 may be made of any suitable material, e.g., metal, plastic, wood, concrete, and other materials such as those listed above. In one particular embodiment, among others, the grate 420 is made of fiberglass reinforced plastic (FRP).

The use of structural materials containing multiple voids in the backplane presents numerous opportunities for efficiently engineering solar cell modules. For example, as illustrated in FIG. 6 a solar cell module 600 includes the features described above with respect to FIG. 5. In this case, PV cells 304A, 304B, and 304C are wired together in series, as is commonly done with solar cell modules. The solar cells may be connected to power cables 602, 604 using voids 513 in the structural material 510 as conduits for electrical wiring. Wire cores of the cables 602, 604 can make electrical contact with the solar cells through holes formed in the upper skin sheet 512 and insulating material 516. The voids 513 acting as the conduits may be filled with pottant 506 to electrically insulate wire cores 606 of the cables and to provide strain relief. Such a configuration allows for compact and simple wiring of the solar cell module 600 through its back side. In a similar fashion, voids 515 may be used as conduits for heating or cooling the solar cells.

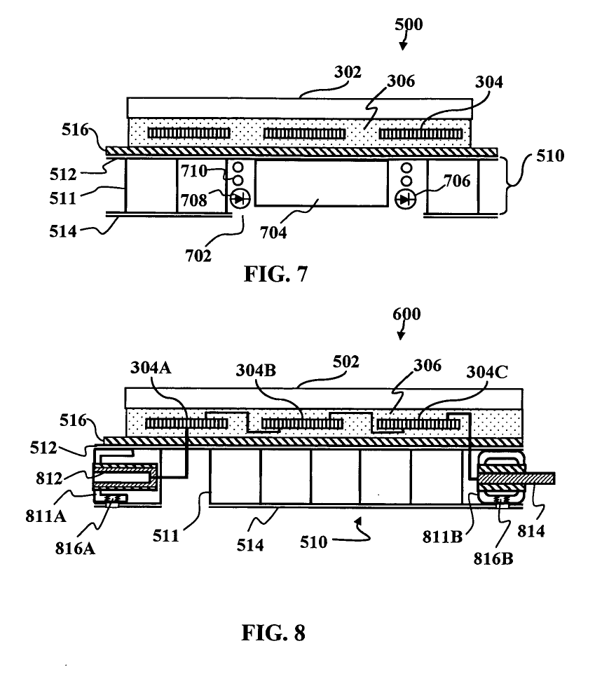

The concept of using the voids in the structural material as conduits can be extended to using the volume occupied by multiple voids as space for integrating other components of a solar cell module. For example, FIG. 7 depicts a solar cell module 700 that includes the features depicted in FIG. 5 and also includes a large void 702 that occupies the volume of several smaller voids. The large void 702 may be created by machining away a portion of the honeycomb material 511 of backplane 510. The large void 702 can provide space for solar cell module components, such as a junction box 704, LED indicator 706, bypass diode 708 or cooling element 710. Other components that could be placed in such a space include but are not limited to an inverter or transformer, dc-dc converter, and/or other processing or control circuitry associated with the operation of the solar module.

The use of void-containing structural elements, such as honeycomb material, also allows for incorporation of solar cell components into an edge of the backplane. For example, FIG. 8 depicts a solar cell module 800 having construction similar to that shown in FIG. 5. In this example, however, the edges of the backplane 510 of the module 800 have been reinforced with edge-strengthening members such as U-channel 811A or Square tube 811B. Solid bar stock may alternatively be used. The edge-strengthening members may be sized to fit between the front and back skin sheets 512, 514 on either side of the structural component 511, e.g., honeycomb. In such a configuration, the edge-strengthening members do not obstruct space for mounting the PV cells 304A, 304B, 304C. In addition to providing structural strength to the edges of the backplane, the edge-strengthening members can also provide a convenient structure for attaching edge-mounted electrical connectors to facilitate electrical interconnection between adjacent solar cell modules.

In the example depicted in FIG. 8, the PV cells are electrically connected in series. A female electrical connector 812 is coupled to a cell 304A (or row of solar cells) proximate one edge of the backplane 810 and a corresponding male electrical connector 814 is coupled to a cell 304C proximate an opposite edge. The male and female electrical connectors 812, 814 allow quick electrical connection of assemblies of multiple solar cell modules. The edge-strengthening members 811A, 811B may also include mechanical attachment means such as tapped holes 816A, 816B to facilitate mounting the module 800 from its underside, e.g., using bolts or screws; they may also include machined slots to capture screwheads or clamping fixtures.

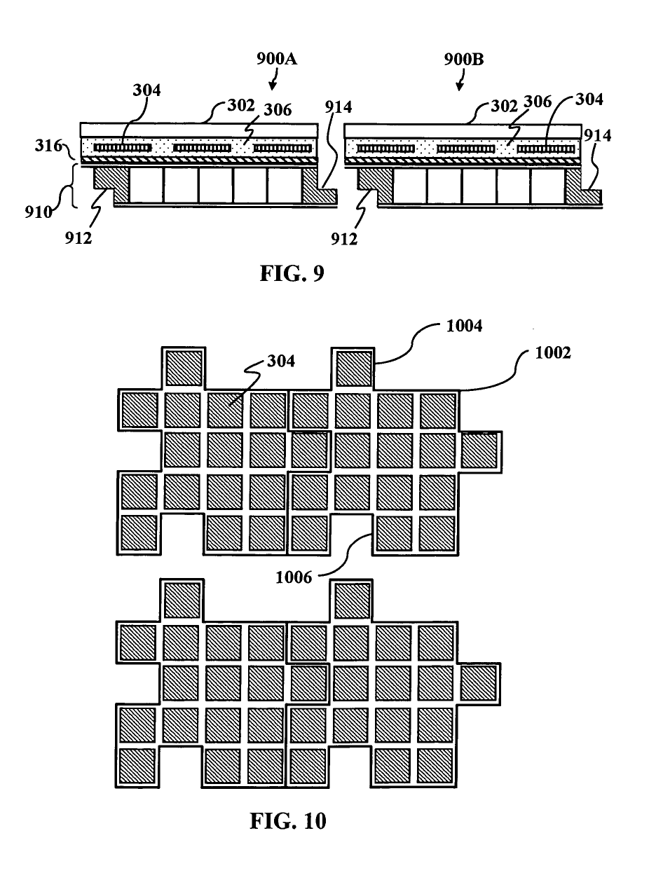

Embodiments of the present invention may also incorporate other features that facilitate mechanical interconnection of assemblies of multiple modules. For example, FIG. 9 depicts a side view cross-section of a pair of solar cell modules 900A, 900B having opposing edges 912, 914 that have been machined to form lap joints. Such overlap joints may facilitate mechanical connection between the solar cell modules 900A, 900B, e.g., using screws. The edges 912, 914 may also be mitered to form miter joints. In alternative embodiments, the edges 912, 914 (with or without edge-strengthening members) may be machined to form other joints, e.g., dovetail joints, tongue-and-groove joints or mortise and tenon joint and the like that permit mechanical assembly without fasteners.

In addition, individual solar cell modules 1002 may be shaped such that they have an interlocking plan, as shown in FIG. 10. Each module 1002 includes a back plane having one or more pins 1004 that are sized and shaped to fit into corresponding tails 1006 on another module. Such a configuration allows interlocking of the modules in a “jigsaw puzzle” fashion. Such solar cell modules 1002 may also include edge-mounted electrical connectors (e.g., as depicted in FIG. 8) or machined edges that form interlocking joints, (e.g., as depicted in FIG. 9).

Embodiments of the present invention provide numerous advantages over the prior art. Principally, the removal of glass from a rigid module greatly reduces the product weight. The light weight will be easier to handle for manufacturing production operators as well as field installation personnel. In addition, the lighter weight can reduce shipping costs. Embodiments of the present invention provide for a module package that is not fragile. There is no need for heavy duty framing to protect the edges. The use of rigid backplanes as described herein obviates the need for expensive laminated backsheets. Instead, much less expensive Polyester can be used to ensure electrical insulation. The back plane material can be more easily machined than glass. As a result, expensive junction boxes can be replaced by creating a cavity for the terminal exit. This can be potted with an insulating material and cables secured with a strain relief for a fraction of the cost of an IP65 rated junction box.

The rigid backplane can be used outside of the encapsulation process. There is no need to mate the encapsulation of the solar cells to the structural support during the initial curing process, as is necessary for optical quality with glass. The non-fragile encapsulate allows for easier handling of the product though the manufacturing process and eliminates costly scrap in the final stages due to glass breakage. The flat back surface can be mounted with adhesives directly to rail support structures. It can be alternately mounted with hardware by machining slots to capture hex bolt caps, or using an edge treatment to allow for clamps. The level front surface will not collect dust and moisture due to frame ledges. Difficult automated framing issues can be avoided.

The perforated rigid substrate may reduce the solar module operating temperature and therefore produce more power than equivalent cell efficiency circuits in standard module construction packages. Solar cell modules according to embodiments of the invention may potentially replace traditional solar module designs that have been in use since at least 1983. The design will cut material costs and have characteristics that will aid in the manufacture, installation, and performance of the solar module. Such solar cell modules may be designed for an end use as a grid utility product. The module may be designed to meet all the performance requirements of IEC 61646 (the International Electrotechnical Commission standard for thin film terrestrial PV modules), as well as all the safety requirements of IEC 61730 (the IEC standard for photovoltaic module safety qualification).

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A solar cell module, comprising:
one or more photovoltaic (PV) cells arranged in a substantially planar fashion, wherein each solar cell has a front side and a back side, wherein the one or more PV cells are adapted to produce an electric voltage when light is incident upon the front side; and
a rigid back plane attached to the one or more PV cells such that the back plane provides structural support from the back side, wherein the rigid back plane includes a structural component having a plurality of voids.

2. The solar cell module of claim 1, further comprising an encapsulant back sheet disposed between the rigid backplane and the one or more PV cells.

3. The solar cell module of claim 1, further comprising a front encapsulant, wherein the solar cell modules are disposed between the front encapsulant and the rigid back plane..

4. The solar cell module of claim 1 wherein the back plane is made of a machinable material.

5. The solar cell module of claim 1 wherein the structural component is made using one or more materials selected from the group of plastics, polypropylene, polycarbonate, Styrofoam, concrete, metal, steel, copper, aluminum, carbon fibers, Kevlar, wood, plywood, fiberboard and other materials with similar elasticity or compressibility properties in the range of the foregoing materials.

6. The solar cell module of claim 1 wherein the structural component is in the form of a wire cloth, perforated material, molded material, fiberglass reinforced plastic grate, or expanded material including but not limited to steel sheet expanded, GP unpolished low-carbon steel, and combinations of these and/or related materials.

7. The solar cell module of claim 1 wherein the structural component includes a honeycomb material, wherein the voids are in the form of honeycomb channels communicating across a thickness of the back plane.

8. The solar cell module of claim 7 wherein the honeycomb channels are characterized by a cell size ranging from about 1/32″ to about 12″

9. The solar cell module of claim 7 wherein the honeycomb material is characterized by a thickness ranging from about 1/32″ to about 12″.

10. The solar cell module of claim 7 wherein the honeycomb material is characterized by a thickness ranging from about ¼″ to about ⅓″.

11. The solar cell module of claim 7 wherein the honeycomb material is characterized by a thickness ranging from about ⅛″ to about ½″.

12. The solar cell module of claim 7, further comprising a skin attached to a support surface of the honeycomb material such that the skin rigidizes the honeycomb material.

13. The solar cell module of claim 12 wherein the skin is made of a textile, plastic sheet or sheet metal.

14. The solar cell module of claim 13, wherein the honeycomb material and skin are made of thermally conductive materials.

15. The solar cell module of claim 7 further comprising a planar element attached to a front support surface of the honeycomb material and a second planar element attached to a back support surface of the honeycomb material, whereby the honeycomb material is sandwiched between the first and second planar elements.

16. The solar cell module of claim 1 wherein the structural component is made of a thermally conductive material.

17. The solar cell module of claim 1 wherein one or more PV cells are electrically insulated from the back plane.

18. The solar cell module of claim 17 wherein the structural member is made of a metal.

19. The solar cell module of claim 18 wherein the metal is aluminum.

20. The solar cell module of claim 17 wherein the structural member is in the form of a honeycomb material.

21. The solar cell module of claim 20 further comprising a skin attached to a support surface of the honeycomb material such that the skin rigidizes the honeycomb material.

22. The solar cell module of claim 21 wherein the skin is made of an electrically insulating material.

23. The solar cell module of claim 21 wherein the skin is made of an electrically conductive material having an insulating coating between the electrically conductive material and the one or more PV cells.

24. The solar cell module of claim 1, wherein the plurality of voids includes a large void that occupies the volume of several smaller voids.

25. The solar cell module of claim 24 further comprising a junction box, LED indicator, bypass diode, transformer, electrical converter, electrical circuit, or cooling element disposed within the large void.

26. The solar cell module of claim 1 wherein one or more of the voids serve as conduits for electrical wiring to the one or more PV cells.

27. The solar cell module of claim 1 wherein one or more of the voids serve as conduits for cooling or heating of the one or more PV cells.

28. The solar cell module of claim 1 wherein one or more of the voids serve as conduits for drainage of the solar cell module.

29. The solar cell module of claim 1, further comprising an edge-strengthening member connected along an edge of the structural member.

30. The solar cell module of claim 29 wherein the edge-strengthening member includes a bar or u-channel.

31. The solar cell module of claim 29 wherein the edge-strengthening member includes one or more holes configured to facilitate mounting of the solar cell module.

32. The solar cell module of claim 1 wherein the solar cell module has a jigsaw puzzle shape that facilitates interconnection of the solar cell module with other correspondingly shaped solar cell modules.

33. The solar cell module of claim 1 wherein an edge of the backplane is configured to provide an overlapping or interlocking joint with correspondingly configured solar cell module.

34. The solar cell module of claim 1 wherein an edge of the backplane includes one or more electrical connectors that facilitate electrical interconnection of the one or more PV cells with other PV cells in another solar cell module.

35. A method for mounting one or more photovoltaic (PV) cells, comprising the steps of:
arranging one or more PV cells in a substantially planar fashion, wherein each PV cell has a front side and a back side, wherein the one or more photovoltaic cells are adapted to produce an electric voltage when light is incident upon the front side; and
attaching a rigid back plane to the one or more PV cells such that the back plane provides structural support from the back side, wherein the back plane includes a structural component having a plurality of voids.

36. The method of claim 35 wherein the structural component includes a honeycomb material, wherein the voids are in the form of honeycomb channels communicating across a thickness of the back plane.

37. The method of claim 36, further comprising the step of attaching a skin to a support surface of the honeycomb material such that the skin rigidizes the honeycomb material.

38. The method of claim 35, further comprising using one or more of the voids as conduits for electrical wiring to the one or more PV cells.

39. The method of claim 35, further comprising using one or more of the voids as conduits for cooling or heating of the one or more PV cells.

40. The method of claim 35, further comprising using one or more of the voids as conduits for drainage.

41. The method of claim 35, further comprising the step of forming a large void in the structural component that occupies the volume of several smaller voids, wherein the large void provides a multifunctional space within the backplane.

42. The method of claim 41, further comprising disposing a junction box, LED indicator, bypass diode, transformer, electrical converter, electrical circuit, or cooling element disposed within the large void.

43. The method of claim 35, further comprising connecting an edge-strengthening member along an edge of the structural member.
